(19) United States
(12) Patent Application Publication
(10) Pub. No.: US 2010/0066859 A1
(43) Pub. Date: Mar. 18, 2010

(54) Image Signal Processing Device, Image Signal Processing Method, Program, Image Imaging Device, and Imaging System

(76) Inventor: Mitsuharu OHKI, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/560,064

(22) Filed: Sep. 15, 2009

(30) Foreign Application Priority Data
Sep. 18, 2008 (JP) P2008-239004

(51) Int. Cl. H04N 5/235

(52) U.S. Cl. 348/229.1; 348/E05.034

(57) ABSTRACT

An image signal processing device includes: an image signal capturing unit capturing first and second image signals obtained by consecutive photographing performed under first and second photographing conditions; an image signal calculation unit obtaining, with the first and second image signals, a weighted addition signal of an image signal based on ambient light and an image signal based on light from a flash device; a display control unit controlling the display of an image based on the weighted addition signal; an input device used to set respective weighting factors of the image signal based on ambient light and the image signal based on light from the flash device subjected to weighted addition; and a photographing condition determination unit determining, on the basis of the weighting factors, the aperture of an aperture mechanism, the exposure time of a solid-state image pickup device, and the light emission amount of the flash device.

### BACKGROUND OF THE INVENTION

1. Field of the Invention

The present invention relates to an image signal processing device, an image signal processing method, a program, an imaging device, and an imaging system. Specifically, the present invention relates to an image signal processing device and so forth which obtain, from image signals obtained by continuous photographing performed with the light emission amount of a flash light emission device set to be zero and a predetermined amount, a weighted addition signal of an image signal based on ambient light and an image signal based on light emitted from the flash light emission device, display an image based on the weighted addition signal on a display unit to allow a photographer to set weighting factors, and determine photographing conditions such as the aperture, the exposure time, and the light emission amount on the basis of the weighing factors set by the photographer, to thereby enable an image intended by the photographer to be easily photographed by an imaging device.

2. Description of the Related Art

In recent years, a digital camera has been widely used which forms an image of a subject on a solid-state image pickup device (e.g., a CCD (Charge-Coupled Device) two-dimensional image sensor) and converts the image into an electrical signal by using a photographing optical system, and which records the resultant image data of the still image on a recording medium such as a semiconductor memory and an optical recording disk.

Many of digital cameras have a function of performing preliminary photographing as preliminary preparation for regular photographing, and automatically adjusting photographing conditions on the basis of the image data of the image of the subject obtained by the preliminary photographing. Therefore, a photographer can perform photographing under appropriate photographing conditions according to the situation, without much expertise.

Photographing in a flash light emission mode will be described more specifically below. The preliminary photographing is performed while a flash light emission device is emitting light reduced to 1/16 of the maximum light emission amount. The image obtained by the preliminary photographing is automatically analyzed by a DSP (Digital Signal Processor) in the camera, and the light emission amount of the flash light emission device in the regular photographing is determined. Then, the regular photographing is performed while the flash light emission device is emitting light of the specified light emission amount. In this case, the DSP automatically determines the light emission amount. In some cases, therefore, the regular photographing is performed with the light emission amount unintended by the photographer. This situation frustrates the user.

As a technique for relieving the frustration, there has been modeling light emission. The modeling light emission refers to consecutive light emission performed with a predetermined minute light emission amount. Prior to the regular photographing, the photographer causes the flash light emission device to perform the modeling light emission to visually check how the subject is applied with the light and how the shadow is formed. Accordingly, the photographer can predict the image resulting from the regular photographing.

In the modeling light emission, however, the light is emitted consecutively. Therefore, there is an issue of excessive power consumption. Further, the consecutive light emission corresponds to the flashing of a flash, in which the brightness increases and diminishes repeatedly, and thus causes eye fatigue. Under such a circumstance, therefore, it is difficult to accurately visually check how the subject is applied with the light and how the shadow is formed.

Japanese Unexamined Patent Application Publication Nos. 2007-267412, 2002-44516, and 10-333235 describe a technique which distinguishes two ranges of a range reached by the light from the flash light emission device and a range not reached by the light on the basis of, for example, the difference between an image obtained with the light emission from the flash light emission device and an image obtained without the light emission from the flash light emission device, and which presents the two distinguished ranges to the photographer, to thereby enable the photographer to predict the image resulting from the regular photographing.

Due to the division into two ranges of the range reached by the light from the flash light emission device and the range not reached by the light, however, detailed information of, for example, a range reached by a certain amount of the light from the flash light emission device and a range reached by a small amount of the light is not presented to the photographer.

### SUMMARY OF THE INVENTION

As described above, in the modeling light emission and the inventions described in the above patent application publications, the information of the image expected to be obtained from the photographing in the flash light emission mode is not previously presented to the photographer accurately and in detail. Further, in the modeling light emission and the inventions described in the above patent application publications, the information of images expected to be photographed with different light emission amounts of the flash light emission device is not previously presented to the photographer.

It is desirable in the present invention to enable an image intended by a photographer to be easily photographed by an imaging device.

According to the concept of an embodiment of the present invention, an image signal processing device includes an image signal capturing unit, an image signal calculation unit, a display control unit, an input device, and a photographing condition determination unit. The image signal capturing unit is configured to capture first and second image signals obtained by consecutive photographing performed by an imaging device under a first photographing condition wherein the aperture of an aperture mechanism of the imaging device is a predetermined aperture, the exposure time of a solid-state image pickup device of the imaging device is a predetermined exposure time, and the light emission amount of a flash light emission device is zero, and a second photographing condition wherein the aperture of the aperture mechanism of the imaging device is a predetermined aperture, the exposure time of the solid-state image pickup device of the imaging device is a predetermined exposure time, and the light emission amount of the flash light emission device is a predetermined light emission amount. The image signal calculation unit is configured to obtain, by the use of the first and second image signals captured by the image signal capturing unit, a weighted addition signal of an image signal based on ambient light and an image signal based on light emitted from the flash light emission device. The display control unit is configured to control the display, on a display unit, of an image based on the weighted addition signal obtained by the image signal calculation unit. The input device is configured to allow a photographer to set respective weighting factors of the image signal based on the ambient light and the image signal based on the light emitted from the flash light emission device, which are subjected to weighted addition by the image signal calculation unit. The photographing condition determination unit is configured to determine, on the basis of the weighting factors set with the input device, the aperture of the aperture mechanism, the exposure time of the solid-state image pickup device, and the light emission amount of the flash light emission device.

The image signal processing device according to the embodiment of the present invention is formed in the imaging device, or is formed by an external device such as a PC (Personal Computer) connected to the imaging device.

In the embodiment of the present invention, the image signal capturing unit captures the first and second image signals. The first and second image signals are obtained by the consecutive photographing performed by the imaging device under the first and second photographing conditions. Herein, in the first photographing condition, the aperture of the aperture mechanism of the imaging device is a predetermined aperture, the exposure time of the solid-state image pickup device of the imaging device is a predetermined exposure time, and the light emission amount of the flash light emission device is zero. In the second photographing condition, the aperture of the aperture mechanism of the imaging device is a predetermined aperture, the exposure time of the solid-state image pickup device of the imaging device is a predetermined exposure time, and the light emission amount of the flash light emission device is a predetermined light emission amount.

Using the first and second image signals described above, the image signal calculation unit obtains the weighted addition signal of the image signal based on the ambient light and the image signal based on the light emitted from the flash light emission device.

If the exposure time of the second photographing condition and the exposure time of the first photographing condition are set to be equal to each other, the second image signal is equal to the image signal based on the ambient light added with the image signal based on the light emitted from the flash light emission device. In this case, the image signal calculation unit may use the first image signal as the image signal based on the ambient light, and may use a subtraction signal resulting from subtraction of the first image signal from the second image signal as the image signal based on the light emitted from the flash light emission device.

Further, if the exposure time of the second photographing condition is set to be sufficiently shorter than the exposure time of the first photographing condition, the component of the image signal based on the ambient light in the second image signal is negligible. In this case, the image signal calculation unit may use the first image signal as the image signal based on the ambient light, and may use the second image signal as the image signal based on the light emitted from the flash light emission device.

The display control unit controls the display, on the display unit, of the image based on the weighted addition signal. Herein, if the image signal processing device is formed in the imaging device, the display unit is a display panel included in the imaging device or an external monitor or the like connected to the imaging device. Meanwhile, if the image signal processing device is formed by an external device such as a PC (Personal Computer), the display unit is a monitor or the like attached to the PC.

The input device (A user operation unit) enables the setting of the respective weighting factors of the image signal based on the ambient light and the image signal based on the light emitted from the flash light emission device, which are subjected to the weighted addition by the image signal calculation unit. In this case, with the use of the set weighting factors, the image signal calculation unit performs the weighted addition on the image signal based on the ambient light and the image signal based on the light emitted from the flash light emission device, to thereby obtain the weighted addition signal. Further, the display unit displays the image based on the weighted addition signal. Therefore, while viewing the image displayed on the display unit, the photographer can set the weighting factors to obtain an intended image.

On the basis of the weighting factors set with the input device, the photographing condition determination unit determines the aperture of the aperture mechanism, the exposure time of the solid-state image pickup device, and the light emission amount of the flash light emission device. If the factor of the image signal based on the ambient light is set to be “1,” for example, the aperture of the aperture mechanism and the exposure time of the solid-state image pickup device are set to be the aperture and the exposure time of the first photographing condition. Further, if the factor of the image signal based on the ambient light is set to be “2,” for example, the aperture is set to be the same and the exposure time is set to be twice, or the aperture is set to be twice and the exposure time is set to be the same, with the aperture and the exposure time of the first photographing condition used as references.

If the factor of the image signal based on the light emitted from the flash light emission device is set to be “1,” for example, the light emission amount of the flash light emission device is determined to be the light emission amount of the second photographing condition. Further, if the factor of the image signal based on the light emitted from the flash light emission device is set to be “2,” for example, the light emission amount of the flash light emission device is determined to be twice, with the light emission amount of the second photographing condition used as a reference.

The thus determined aperture, exposure time, and light emission amount are set as the aperture of the aperture mechanism of the imaging device, the exposure time of the solid-state image pickup device of the imaging device, and the light emission amount of the flash light emission device. Accordingly, the photographer can easily photograph an intended image.

The aperture, exposure time, and light emission amount determined as described above may be displayed on, for example, the display unit, and the photographer viewing the display may manually set the aperture, exposure time, and light emission amount in the imaging device and the flash light emission device. Alternatively, the image signal processing device may further include a photographing condition setting unit which automatically sets the aperture, exposure time, and light emission amount.

The embodiment of the present invention may also be configured, for example, such that the display control unit controls the display, on the display unit, of the image obtained from the image signal based on the ambient light and the image obtained from the image signal based on the light emitted from the flash light emission device, as well as the image based on the weighted addition signal obtained by the image signal calculation unit. This configuration enables the photographer to visually check, for example, the image obtained from the image signal based on the ambient light and the image obtained by the image signal based on the light emitted from the flash light emission device.

According to the embodiment of the present invention, on the basis of the image signals obtained by the consecutive photographing performed with the light emission amount of the flash light emission device set to be zero and a predetermined amount, the weighted addition signal of the image signal based on the ambient light and the image signal based on the light emitted from the flash light emission device is obtained. Further, the image based on the weighted addition signal is displayed on the display unit to allow the photographer to set the weighing factors. Then, on the basis of the weighting factors set by the photographer, the photographing conditions such as the aperture, the exposure time, and the light emission amount are determined. Accordingly, the image intended by the photographer can be easily photographed by the imaging device.

### BRIEF DESCRIPTION OF THE DRAWINGS

FIG. 1 is a block diagram illustrating a configuration example of an imaging system as an embodiment of the present invention;

FIG. 2 is a diagram for explaining a state of photographing by the imaging system;

FIG. 3 is a diagram illustrating an example of an image photographed by the use of the imaging system;

FIG. 4 is a block diagram illustrating a configuration example of a digital camera forming the imaging system;

FIG. 5 is a flowchart for explaining control processing performed by a CPU in actual photographing;

FIG. 6 is a flowchart for explaining a monitoring control process by the CPU;

FIG. 7 is a diagram for explaining images obtained by photographing for monitoring performed prior to regular photographing and images obtained by processes;

FIG. 8 is a diagram for explaining images obtained by photographing for monitoring performed prior to regular photographing and images obtained by processes;

FIG. 9 is a diagram for explaining images obtained by photographing for monitoring performed prior to regular photographing and images obtained by processes; and

FIG. 10 is a diagram for explaining images obtained by photographing for monitoring performed prior to regular photographing and images obtained by processes.

### DESCRIPTION OF THE PREFERRED EMBODIMENTS

A preferred embodiment for implementing the invention (hereinafter referred to as an “embodiment”) will be described below. The description will be made in the following order: 1. Embodiment and 2. Modified Examples.

### 1. Embodiment

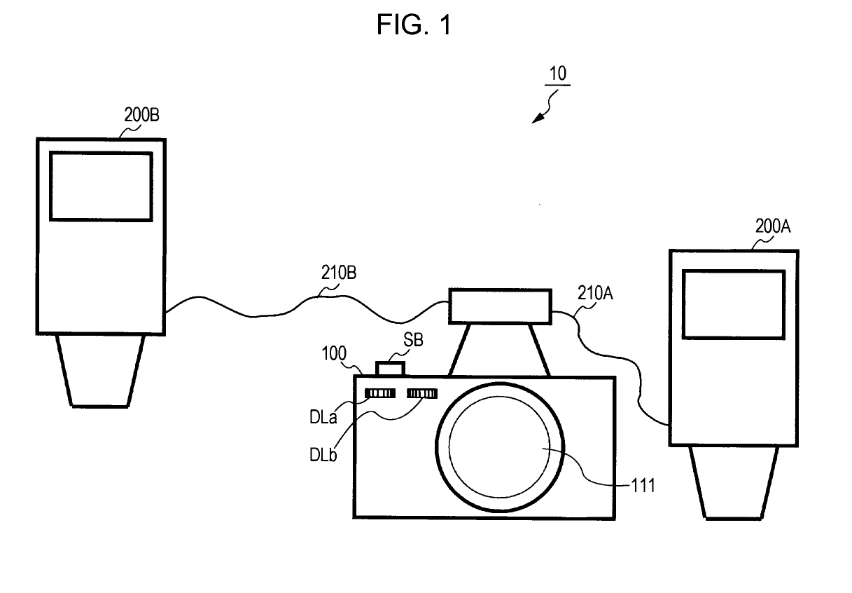

Configuration Example of Imaging System: FIG. 1 illustrates a configuration example of an imaging system 10 as an embodiment.

The imaging system 10 is configured to include a digital camera 100 serving as an imaging device and two flash light emission devices 200A and 200B. The flash light emission devices 200A and 200B, which emit flash light, are connected to the digital camera 100 by transmission lines 210A and 210B, respectively, and controlled by control signals transmitted from the digital camera 100 through the transmission lines 210A and 210B, respectively.

The method of transmitting the control signals from the digital camera 100 to the flash light emission devices 200A and 200B is not limited to a wired method using the transmission lines 210A and 210B, but may be a wireless method which wirelessly transmits the control signals. In the wireless method, the transmission lines 210A and 210B are unnecessary. This wireless method is described in, for example, Japanese Unexamined Patent Application Publication No. 04-343343 and so forth, and has been commonly used in the past.

The upper surface of a housing of the digital camera 100 is provided with a shutter button SB. Further, the front surface of the housing of the digital camera 100 is provided with a photographing lens 111 and dials DLa and DLb for allowing a photographer to set weighting factors of an image signal based on ambient light and image signals based on light emitted from the flash light emission devices 200A and 200B, which will be described later. The dial DLa is a dial for selecting the image signal, for which the weighting factors are to be set. The dial DLb is a dial for setting the values of the weighting factors. A detailed configuration of the digital camera 100 will be described later.

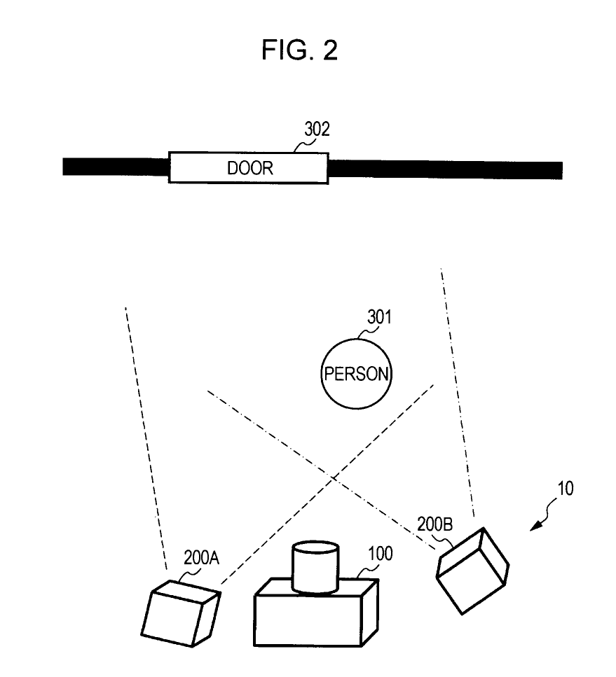

Example of Photographing State: FIG. 2 illustrates an example of the state of photographing using the imaging system 10 of FIG. 1. FIG. 2 is a diagram illustrating the photographing state, as viewed from above. The digital camera 100 and the flash light emission devices 200A and 200B have the positional relationship as illustrated in FIG. 2. The illustration of the transmission lines 210A and 210B is omitted.

In FIG. 2, a photographing target person 301 is located at a position near the imaging system 10, and is in a range reached by the light from the flash light emission devices 200A and 200B. A door 302 located behind the photographing target person 301 is an object forming the background. The door 302 is located at a position far from the imaging system 10, and is in a range not reached by the light from the flash light emission devices 200A and 200B.

The flash light emission device 200A illuminates the photographing target person 301 from the left side of the digital camera 100. The flash light emission device 200B illuminates the photographing target person 301 from the right side of the digital camera 100. In FIG. 2, the direction of the light emitted from the flash light emission device 200A is indicated by dashed lines, and the direction of the light emitted from the flash light emission device 200B is indicated by dot-dashed lines.

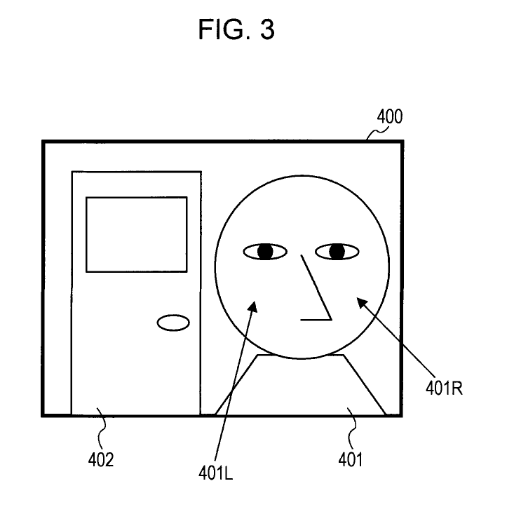

FIG. 3 illustrates a photographed image 400 obtained by photographing in the photographing state of FIG. 2. The actual photographed image 400 is an image having bright and dark portions, as described later. Herein, only the outlines of the image are drawn for explanation of the composition (the positional relationship) of the subjects included in the image. As illustrated in FIG. 3, the photographed image 400 includes a projected image 401 of the photographing target person 301 and a projected image 402 of the door 302.

A left-side projected image 401L of the projected image 401 of the photographing target person 301 corresponds to the projected image of a portion best reached by the light from the flash light emission device 200A. A right-side projected image 401R of the projected image 401 corresponds to the projected image of a portion on the opposite side away from the flash light emission device 200A, i.e., the projected image of a portion not reached by much of the light from the flash light emission device 200A.

Similarly, the right-side projected image 401R of the projected image 401 of the photographing target person 301 corresponds to the projected image of a portion best reached by the light from the flash light emission device 200B. The left-side projected image 401L of the projected image 401 corresponds to the projected image of a portion on the opposite side away from the flash light emission device 200B, i.e., the projected image of a portion not reached by much of the light from the flash light emission device 200B.

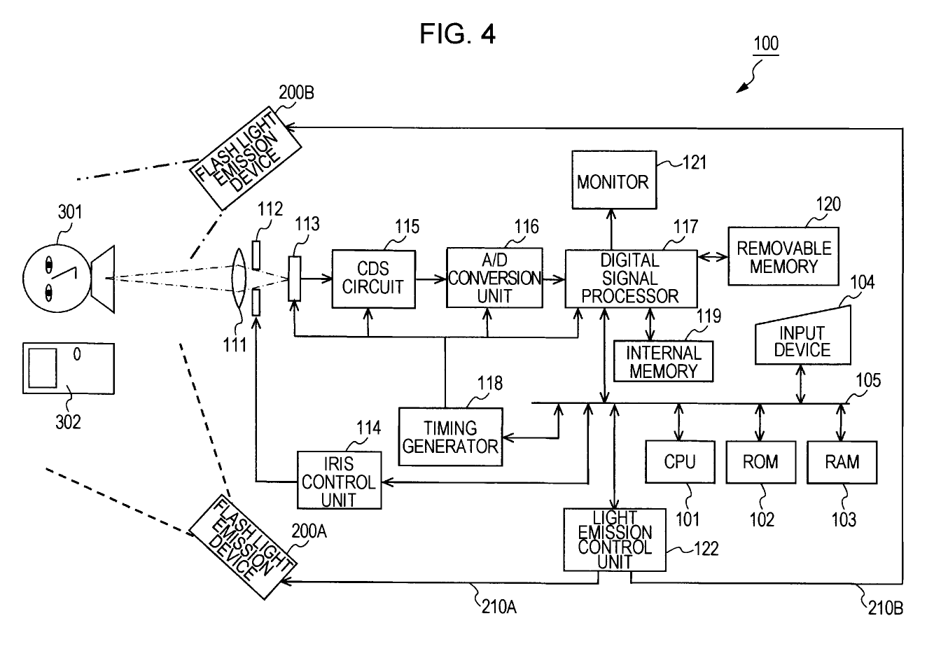

Configuration Example of Digital Camera: A configuration example of the digital camera 100 will be described. FIG. 4 illustrates a configuration example of the digital camera 100. The digital camera 100 includes a CPU (Central Processing Unit) 101, a ROM (Read Only Memory) 102, a RAM (Random Access Memory) 103, and an input device (a user operation unit) 104. The digital camera 100 further includes the photographing lens 111, an iris 112 serving as an aperture mechanism, an image pickup device 113, an iris control unit 114, a CDS (Correlated Double Sampling) circuit 115, an A/D (Analog/Digital) conversion unit 116, and a digital signal processor (DSP) 117. The digital camera 100 further includes a timing generator 118, an internal memory 119, a removable memory 120, a monitor 121, and a light emission control unit 122.

The CPU 101 forms a control unit for controlling the respective parts of the digital camera 100. The ROM 102 stores, for example, a control program of the CPU 101. The RAM 103 is used to, for example, temporarily store data used in control processing of the CPU 101. The CPU 101 expands, on the RAM 103, a program or data read from the ROM 102, and activates the program to control the respective parts of the digital camera 100.

The input device 104 forms a user interface, and is connected to the CPU 101 via a bus 105. The input device 104 is configured to include keys, buttons, dials, and so forth provided on a not-illustrated surface of the housing of the digital camera 100. The shutter button SB and the dials DLa and DLb described above are also included in the input device 104. The CPU 101 analyzes information input from the input device 104 via the bus 105, and performs a control according to the operation performed by the photographer.

Light from a subject passes through an optical system, i.e., the photographing lens 111 and the iris 112, and is incident on the image pickup device 113. In this case, the light from the subject is condensed by the photographing lens 111, and only a part of the light collected by the iris 112 reaches the image pickup device 113. The aperture of the iris 112 is controlled by the iris control unit 114. The image pickup device 113 is configured to include, for example, a CCD (Charge Coupled Device) image sensor, a CMOS (Complementary Metal Oxide Semiconductor) image sensor, or the like. The image pickup device 113 performs image pickup processing in a state in which an optical image of the subject is formed on an image pickup surface, and outputs a picked-up image signal.

The CDS circuit 115 performs correlated double sampling on the picked-up image signal supplied by the image pickup device 113 to remove a noise component from the signal, and thereafter supplies the picked-up image signal to the A/D conversion unit 116. The A/D conversion unit 116 performs analog-to-digital signal conversion on the picked-up image signal supplied by the CDS circuit 115, and thereafter supplies the picked-up image signal to the digital signal processor 117.

The digital signal processor 117 performs image processing on the picked-up image signal supplied by the A/D conversion unit 116. The image processing herein includes demosaic processing, white balance processing, gamma correction processing, and so forth. The processing is performed by almost all general-purpose digital cameras, and thus detailed description thereof will be omitted. The image data processed by the digital signal processor 117 is in a general-purpose image format.

The digital signal processor 117 transfers the processed image data to the internal memory 119 for temporarily storing the image data, and also transfers the image data to the removable memory 120 for finally storing the image data. The removable memory 120 includes a memory card and so forth. The removable memory 120 is detachable from the digital camera 100. The detached removable memory 120 can be installed in a PC (Personal Computer) or the like to enable the viewing of the image stored therein.

The digital signal processor 117 also reads the data from the internal memory 119 or the removable memory 120, and displays the data on the monitor 121. The monitor 121 is formed by, for example, a display panel such as an LCD (Liquid Crystal Display) provided on, for example, the rear surface of the housing of the digital camera 100.

The light emission control unit 122 controls the light emission of the flash light emission devices 200A and 200B. Under the control of the CPU 101, the light emission control unit 122 transmits instructions relating to the light emission timing and the light emission amount to the flash light emission devices 200A and 200B via the transmission lines 210A and 210B, respectively.

Flow of Photographing Process: Subsequently, description will be made of a process flow of photographing actually performed with the use of the imaging system 10 illustrated in FIG. 1. Prior to this process, the photographer operates the input device 104 to set whether or not to perform photographing in the flash light emission mode, and whether or not to perform monitoring in the photographing in the flash light emission mode. The photographer setting information from the input device 104 is transmitted to the CPU 101 via the bus 105.

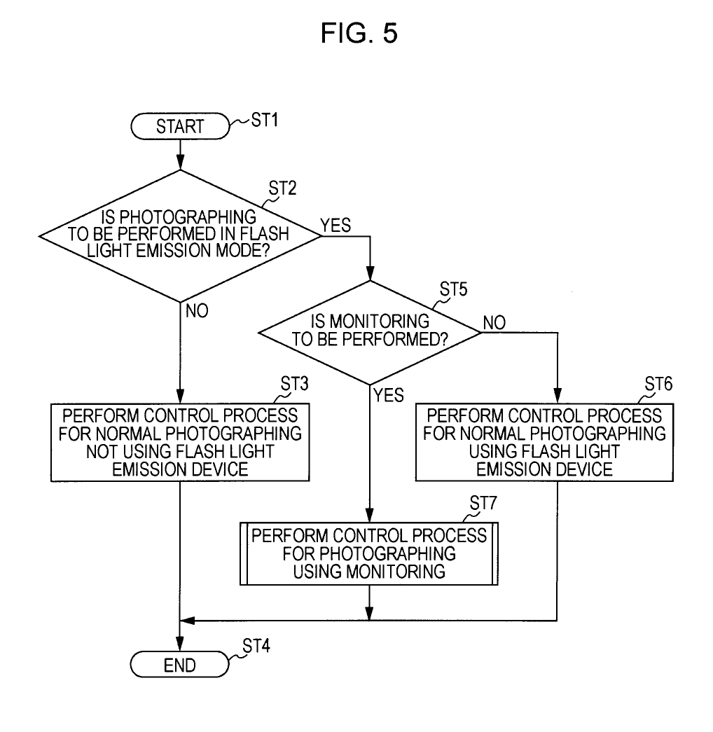

The flowchart of FIG. 5 illustrates the control processing performed by the CPU 101 in the actual photographing.

The CPU 101 at Step ST1 starts the control processing in accordance with a power-on operation performed by the photographer, and thereafter moves to the process of Step ST2. At this Step ST2, the CPU 101 determines whether or not the photographing is to be performed in the flash light emission mode. If the photographing is not to be performed in the flash light emission mode, the CPU 101 at Step ST3 performs a control process for normal photographing not using a flash light emission device.

This control process is similar to the control process which has been performed in the past in photographing not using a flash light emission device, and thus is commonly used. Therefore, detailed description thereof will be omitted. In this photographing process, the CPU 101 performs normal photographing not using a flash light emission device, processes the result of the photographing at the digital signal processor 117 to convert the result into a general-purpose image format, and records the result in the removable memory 120. After the control process of Step ST3, the CPU 101 at Step ST4 completes the processing.

Meanwhile, if it is determined at Step ST2 that the photographing is to be performed in the flash light emission mode, the CPU 101 at Step ST5 determines whether or not to perform the monitoring. If the monitoring is not to be performed, the CPU 101 moves to the process of Step ST6. At this Step ST6, the CPU 101 performs a control process for normal photographing using a flash light emission device. This control process is similar to the control process which has been performed in the past in photographing using a flash light emission device, and thus is commonly used. Therefore, detailed description thereof will be omitted. In this photographing process, the CPU 101 performs normal photographing using a flash light emission device, processes the result of the photographing at the digital signal processor 117 to convert the result into a general-purpose image format, and records the result in the removable memory 120. After the control process of Step ST6, the CPU 101 at Step ST4 completes the processing.

Meanwhile, if it is determined at Step ST5 that the monitoring is to be performed, the CPU 101 at Step ST7 performs a control process for photographing using the monitoring (a monitoring control process). After the control process of Step ST7, the CPU 101 at Step ST4 completes the processing.

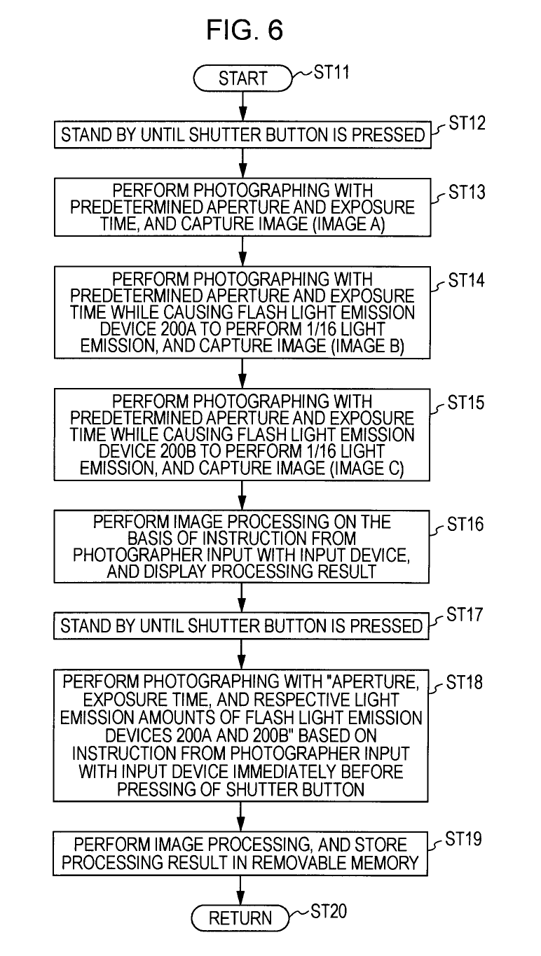

Monitoring Control Process: The monitoring control process will be described. The flowchart of FIG. 6 expands on Step ST7 in the flowchart of FIG. 5.

The CPU 101 at Step ST11 starts the process, and thereafter moves to the process of Step ST12. At this Step ST12, the CPU 101 stands by until the shutter button SB (see FIG. 1) forming the input device 104 is pressed by the photographer. If the shutter button SB is pressed, the CPU 101 moves to the process of Step ST13.

At this Step ST13, the CPU 101 performs photographing with a predetermined aperture (hereinafter referred to as “F”) and a predetermined exposure time (hereinafter referred to as “S”). In this process, the CPU 101 transmits a light emission prohibition command to the light emission control unit 122 via the bus 105. Accordingly, the light emission control unit 122 does not transmit a light emission signal to the flash light emission devices 200A and 200B. In the photographing, therefore, there is no light emission from the flash light emission devices 200A and 200B.

With this photographing, it is possible to obtain an image photographed under illumination by a light source including only ambient light (e.g., sunlight, the illustration of which is omitted). In this case, the picked-up image signal obtained from the image pickup device 113 is supplied to the digital signal processor 117 via the CDS circuit 115 and the A/D conversion unit 116, and is processed therein. Then, the processed image signal (hereinafter referred to as “A”) is converted into a general-purpose image format and stored in the internal memory 119.

After the process of Step ST13, the CPU 101 moves to the process of Step ST14. At this Step ST14, the CPU 101 performs photographing with the aperture F and the exposure time S, which are the same as the aperture and the exposure time used at the above-described Step ST13, while causing the flash light emission device 200A to perform 1/16 light emission. In this process, the CPU 101 transmits to the light emission control unit 122, via the bus 105, a command to “instruct the flash light emission device 200A to emit light in a pre-light emission mode” and “prohibit the flash light emission device 200B from emitting light.”

Thereby, the light emission control unit 122 transmits to the flash light emission device 200A a signal for emitting light reduced to “ 1/16 of the maximum light emission amount.” At the same time, the light emission control unit 122 does not transmit a light emission signal to the flash light emission device 200B. In the photographing, therefore, only the flash light emission device 200A emits light (the amount of the light is 1/16 of the maximum light emission amount). With this photographing, it is possible to obtain an image photographed under illumination by a light source including two types of light, i.e., the ambient light (e.g., sunlight, the illustration of which is omitted) and the light from the flash light emission device 200A. In this case, the picked-up image signal obtained from the image pickup device 113 is supplied to the digital signal processor 117 via the CDS circuit 115 and the A/D conversion unit 116, and is processed therein. Then, the processed image signal (hereinafter referred to as “B”) is converted into a general-purpose image format and stored in the internal memory 119.

After the process of Step ST14, the CPU 101 moves to the process of Step ST15. At this Step ST15, the CPU 101 performs photographing with the aperture F and the exposure time S, which are the same as the aperture and the exposure time used at the above-described Step ST13, while causing the flash light emission device 200B to perform 1/16 light emission. In this process, the CPU 101 transmits to the light emission control unit 122, via the bus 105, a command to “instruct the flash light emission device 200B to emit light in a pre-light emission mode” and “prohibit the flash light emission device 200A from emitting light.”

Thereby, the light emission control unit 122 transmits to the flash light emission device 200B a signal for emitting light reduced to “ 1/16 of the maximum light emission amount.” At the same time, the light emission control unit 122 does not transmit a light emission signal to the flash light emission device 200A. In the photographing, therefore, only the flash light emission device 200B emits light (the amount of the light is 1/16 of the maximum light emission amount). With this photographing, it is possible to obtain an image photographed under illumination by a light source including two types of light, i.e., the ambient light (e.g., sunlight, the illustration of which is omitted) and the light from the flash light emission device 200B. In this case, the picked-up image signal obtained from the image pickup device 113 is supplied to the digital signal processor 117 via the CDS circuit 115 and the A/D conversion unit 116, and is processed therein. Then, the processed image signal (hereinafter referred to as “C”) is converted into a general-purpose image format and stored in the internal memory 119.

After the process of Step ST15, the CPU 101 moves to the process of Step ST16. At this Step ST16, on the basis of the instruction from the photographer input with the input device 104, the CPU 101 performs image processing at the digital signal processor 117, and displays the result of the image processing on the monitor 121. Details of the process of Step ST16 will be described later. The process of Step ST16 is performed every time the instruction from the photographer input with the input device 104 is received.

After the process of Step ST16, the CPU 101 moves to the process of Step ST17. At this Step ST17, the CPU 101 stands by until the shutter button SB (see FIG. 1) forming the input device 104 is pressed by the photographer. If the shutter button SB is pressed, the CPU 101 moves to the process of Step ST18.

That is, at Steps ST16 and ST17, the CPU 101 performs a process in which “every time the instruction from the photographer input with the input device 104 is received, the CPU 101 performs image processing based on the instruction (weighted addition processing) at the digital signal processor 117 and displays the result of the image processing on the monitor 121, until the shutter button SB is pressed, and proceeds to the process of Step ST18 when the shutter button SB is pressed.”

The CPU 101 at Step ST18 determines and sets “the aperture, the exposure time, the light emission amount of the flash light emission device 200A, and the light emission amount of the flash light emission device 200B” based on the instruction from the photographer input with the input device 104 immediately before the pressing of the shutter button SB, and performs photographing. This photographing is the regular photographing. The setting of the specific values of the aperture and so forth will be described later.

Then, the CPU 101 at Step ST19 processes, at the digital signal processor 117, the picked-up image signal obtained from the image pickup device 113 in the photographing performed at Step ST18, converts the processed image signal into a general-purpose image format, and stores the image signal in the removable memory 120. After the process of Step ST19, the CPU 101 at Step ST20 returns.

Subsequently, the details of the process of Step ST16 in the flowchart of FIG. 6 and the specific values set at Step ST18 in the flowchart of FIG. 6 will be described.

Instruction from Photographer and Image Processing: “The instruction from the photographer input with the input device 104” at Step ST16 in the flowchart of FIG. 6 specifically includes “the intensity of the ambient light,” “the intensity of the light from the flash light emission device 200A,” “the intensity of the light from the flash light emission device 200B,” and “the type of the image displayed on the monitor 121.”

“The intensity of the ambient light” is selected from, for example, “⅛ times,” “¼ times,” “½ times,” “1 time,” “2 times,” “4 times,” and “8 times.” This value will be referred to as “P.” That is, the value P is one of ⅛, ¼, ½, 1, 2, 4, and 8. “The intensity of the light from the flash light emission device 200A” is selected from, for example, “0 time,” “½ times,” “1 time,” “2 times,” “4 times,” “8 times,” and “16 times.” This value will be referred to as “Q.” That is, the value Q is one of 0, ½, 1, 2, 4, 8, and 16.

“The intensity of the light from the flash light emission device 200B” is selected from, for example, “0 time,” “½ times,” “1 time,” “2 times,” “4 times,” “8, times” and “16 times.” This value will be referred to as “R.” That is, the value R is one of 0, ½, 1, 2, 4, 8, and 16. “The type of the image displayed on the monitor 121” is selected from, for example, “the image based on the ambient light,” “the image based on the light from the flash light emission device 200A,” “the image based on the light from the flash light emission device 200B,” and “the image based on the ambient light and the light from the flash light emission devices 200A and 200B.”

“The image processing at the digital signal processor 117” performed at Step ST16 in the flowchart of FIG. 6 specifically includes the following processes (1) to (6).

In the process (1), the image signal A stored in the internal memory 119 is subtracted from the image signal B stored in the internal memory 119. The resultant image signal will be referred to as “BA.”

In the process (2), the image signal A stored in the internal memory 119 is subtracted from the image signal C stored in the internal memory 119. The resultant image signal will be referred to as “CA.”

In the process (3), the image signal A stored in the internal memory 119 is multiplied by the magnification of “the intensity of the ambient light” specified by the photographer. The resultant image signal will be referred to as “AM.”

In the process (4), the image signal BA is multiplied by the magnification of “the intensity of the light from the flash light emission device 200A” specified by the photographer. The resultant image signal will be referred to as “BAM.”

In the process (5), the image signal CA is multiplied by the magnification of “the intensity of the light from the flash light emission device 200B” specified by the photographer. The resultant image signal will be referred to as “CAM.”

In the process (6), three image signals AM, BAM, and CAM are added together. The resultant image signal will be referred to as “M.”

The types of image signals produced by the above-described processes will be described. The image signal A is obtained by photographing performed with the aperture F and the exposure time S under illumination by a light source including the ambient light. The image signal B is obtained by photographing performed with the aperture F and the exposure time S under illumination by a light source including two types of light, i.e., the ambient light and the light from the flash light emission device 200A (the amount of the light is 1/16 of the maximum light emission amount). The image signal C is obtained by photographing performed with the aperture F and the exposure time S under illumination by a light source including two types of light, i.e., the ambient light and the light from the flash light emission device 200B (the amount of the light is 1/16 of the maximum light emission amount).

The image signal BA is obtained by subtraction of the image signal A from the image signal B. That is, the image signal BA is equivalent to the image signal obtained by photographing performed with the aperture F under illumination by a light source including the light from the flash light emission device 200A (the amount of the light is 1/16 of the maximum light emission amount) in a state in which the ambient light is absent. The illumination by the flash light emission device 200A is instantaneous, and the level of the image signal BA does not rely on the exposure time S.

The image signal CA is obtained by subtraction of the image signal A from the image signal C. That is, the image signal CA is equivalent to the image signal obtained by photographing performed with the aperture F under illumination by a light source including the light from the flash light emission device 200B (the amount of the light is 1/16 of the maximum light emission amount) in a state in which the ambient light is absent. The illumination by the flash light emission device 200B is instantaneous, and the level of the image signal CA does not rely on the exposure time S.

The image signal AM is obtained by multiplication of the image signal A by the value P. The image signal AM is equivalent to the image signal obtained by photographing performed with the aperture F and an exposure time P times as long as the exposure time S under illumination by a light source including the ambient light. Alternatively, the image signal AM is equivalent to the image signal obtained by photographing performed with an aperture P times as bright as the aperture F and the exposure time S under illumination by a light source including only the ambient light.

The image signal BAM is obtained by multiplication of the image signal BA by the value Q. The image signal BAM is equivalent to the image signal obtained by photographing performed with the aperture F under illumination by a light source including the light from the flash light emission device 200A (the amount of the light is Q/16 of the maximum light emission amount) in a state in which the ambient light is absent. Alternatively, the image signal BAM is equivalent to the image signal obtained by photographing performed with an aperture P times as bright as the aperture F under illumination by a light source including the light from the flash light emission device 200A (the amount of the light is Q/(P×16) of the maximum light emission amount) in a state in which the ambient light is absent.

The image signal CAM is obtained by multiplication of the image signal CA by the value R. The image signal CAM is equivalent to the image signal obtained by photographing performed with the aperture F under illumination by a light source including the light from the flash light emission device 200B (the amount of the light is R/16 of the maximum light emission amount) in a state in which the ambient light is absent. Alternatively, the image signal CAM is equivalent to the image signal obtained by photographing performed with an aperture P times as bright as the aperture F under illumination by a light source including the light from the flash light emission device 200B (the amount of the light is R/(P×16) of the maximum light emission amount) in a state in which the ambient light is absent.

The image signal M is obtained by addition of three image signals AM, BAM, and CAM. The image signal M is equivalent to the image signal obtained by photographing performed with the aperture F and an exposure time P times as long as the exposure time S under illumination by a light source including three types of light, i.e., the ambient light, the light from the flash light emission device 200A (the amount of the light is Q/16 of the maximum light emission amount), and the light from the flash light emission device 200B (the amount of the light is R/16 of the maximum light emission amount). Alternatively, the image signal M is equivalent to the image signal obtained by photographing performed with an aperture P times as bright as the aperture F and the exposure time S under illumination by a light source including three types of light, i.e., the ambient light, the light from the flash light emission device 200A (the amount of the light is Q/(P×16) of the maximum light emission amount), and the light from the flash light emission device 200B (the amount of the light is R/(P×16) of the maximum light emission amount).

The image “displayed on the monitor 121” at Step ST16 in the flowchart of FIG. 6 is based on the above-described image signal AM, if “the type of the image displayed on the monitor 121” specified by the photographer is “the image based on the ambient light.” If “the type of the image displayed on the monitor 121” specified by the photographer is “the image based on the light from the flash light emission device 200A,” the image “displayed on the monitor 121” is based on the above-described image signal BAM. Further, if “the type of the image displayed on the monitor 121” specified by the photographer is “the image based on the light from the flash light emission device 200B,” the image “displayed on the monitor 121” is based on the above-described image signal CAM. Further, if “the type of the image displayed on the monitor 121” specified by the photographer is “the image based on the ambient light and the light from the flash light emission devices 200A and 200B,” the image “displayed on the monitor 121” is based on the above-described image signal M.

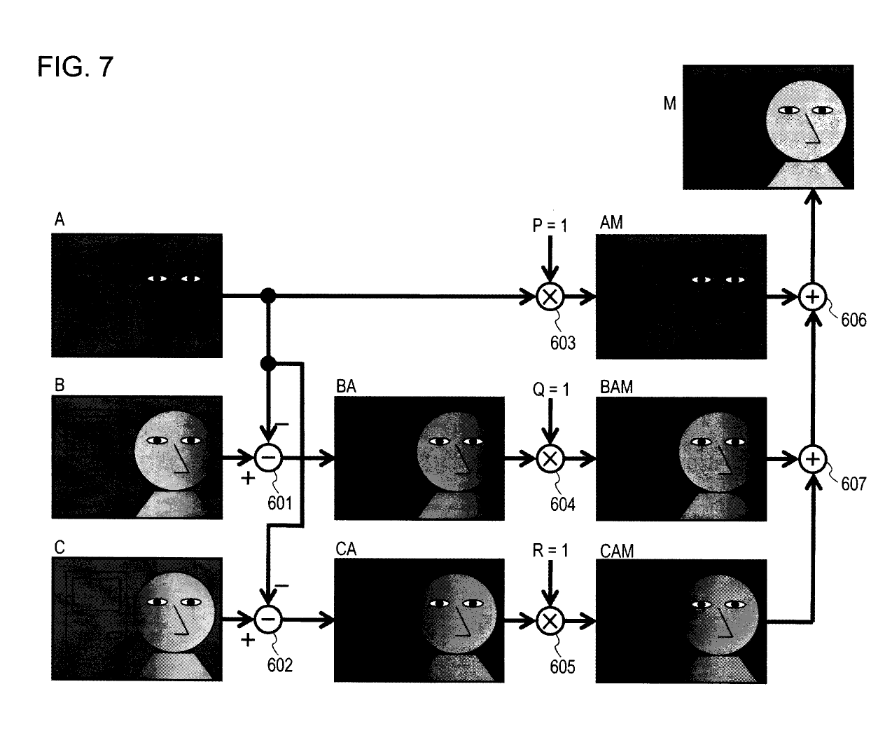

Immediately after the shift from the process of Step ST15 to the process of Step ST16, i.e., in a default state, settings are made such that “the intensity of the ambient light (e.g., sunlight, the illustration of which is omitted)” is 1 time, that “the intensity of the light from the flash light emission device 200A” is 1 time, that “the intensity of the light from the flash light emission device 200B” is 1 time, and that “the type of the image displayed on the monitor 121” is “the image based on the ambient light and the light from the flash light emission devices 200A and 200B.” That is, each of the values P, Q, and R is 1. This matter will be described in detail with reference to FIG. 7.

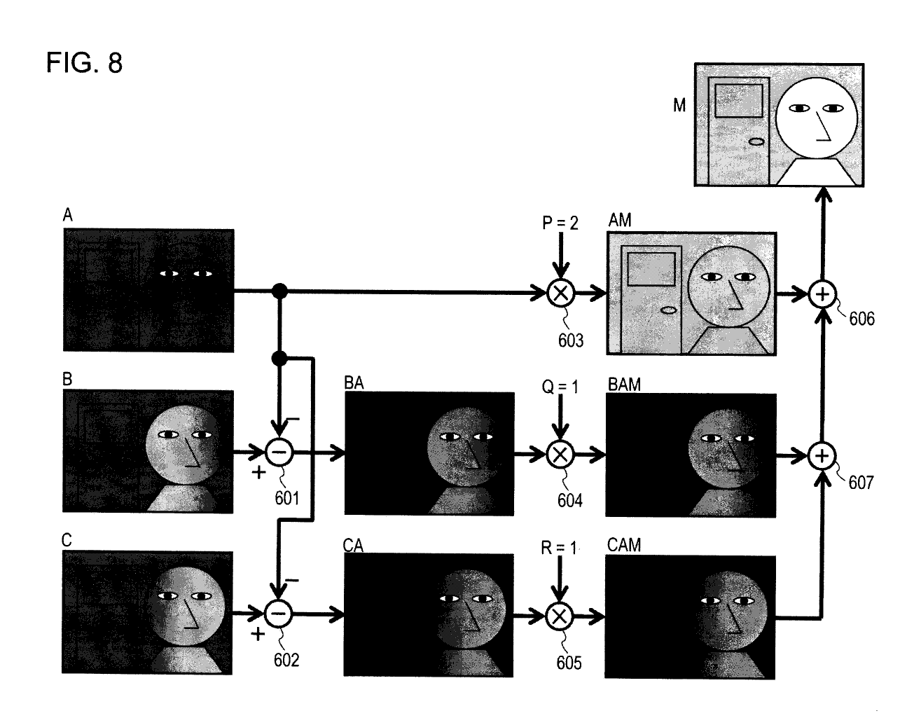

In FIG. 7, “A,” “B,” “C,” “BA,” “CA,” “AM,” “BAM,” “CAM,” and “M” indicate “the image based on the image signal A,” “the image based on the image signal B,” “the image based on the image signal C,” “the image based on the image signal BA,” “the image based on the image signal CA,” “the image based on the image signal AM,” “the image based on the image signal BAM,” “the image based on the image signal CAM,” and “the image based on the image signal M,” respectively. Also in FIGS. 8 to 10 described later, the reference letter “A” and so forth similarly indicate the respective images.

In FIG. 7, a subtraction process 601, a subtraction process 602, a multiplication process 603, a multiplication process 604, a multiplication process 605, and “two addition processes 606 and 607” indicate the above-described processes (1) to (6) of Step ST16, respectively. Also in FIGS. 8 to 10 described later, the subtraction process 601 and so forth similarly indicate the processes (1) to (6).

As illustrated in A of FIG. 7, in the image based on the image signal A, the projected image of the door 302 (the projected image 402 described in FIG. 3), the left side of the projected image of the person (the projected image 401L illustrated in FIG. 3), and the right side of the projected image of the person (the projected image 401R illustrated in FIG. 3) all appear somewhat dark.

As illustrated in B of FIG. 7, in the image based on the image signal B, the projected image of the door 302 (the projected image 402 described in FIG. 3) and the right side of the projected image of the person (the projected image 401R illustrated in FIG. 3) appear somewhat dark. Meanwhile, the left side of the projected image of the person (the projected image 401L illustrated in FIG. 3) appears somewhat bright due to the light from the flash light emission device 200A.

As illustrated in C of FIG. 7, in the image based on the image signal C, the projected image of the door 302 (the projected image 402 described in FIG. 3) and the left side of the projected image of the person (the projected image 401L illustrated in FIG. 3) appear somewhat dark. Meanwhile, the right side of the projected image of the person (the projected image 401R illustrated in FIG. 3) appears somewhat bright due to the light from the flash light emission device 200B.

As illustrated in BA of FIG. 7, in the image based on the image signal BA, the projected image of the door 302 (the projected image 402 described in FIG. 3) appears almost black. Further, the right side of the projected image of the person (the projected image 401R illustrated in FIG. 3) appears somewhat dark, and the left side of the projected image of the person (the projected image 401L illustrated in FIG. 3) appears somewhat bright. The reason for the projected image of the door 302 (the projected image 402 described in FIG. 3) appearing almost black is that the light from the flash light emission device 200A does not reach the door 302.

As illustrated in CA of FIG. 7, in the image based on the image signal CA, the projected image of the door 302 (the projected image 402 described in FIG. 3) appears almost black. Further, the left side of the projected image of the person (the projected image 401L illustrated in FIG. 3) appears somewhat dark, and the right side of the projected image of the person (the projected image 401R illustrated in FIG. 3) appears somewhat bright. The reason for the projected image of the door 302 (the projected image 402 described in FIG. 3) appearing almost black is that the light from the flash light emission device 200B does not reach the door 302.

In AM, BAM, and CAM of FIG. 7, each of the values P, Q, and R is 1. Therefore, AM, BAM, and CAM are equal to A, BA, and CA, respectively. As illustrated in M of FIG. 7, in the image based on the image signal M, the projected image of the door 302 (the projected image 402 described in FIG. 3) appears somewhat dark. Further, the left side of the projected image of the person (the projected image 401L illustrated in FIG. 3) appears somewhat bright due to the light from the flash light emission device 200A. Further, the right side of the projected image of the person (the projected image 401R illustrated in FIG. 3) appears somewhat bright due to the light from the flash light emission device 200B.

“The type of the image displayed on the monitor 121” has been set to be “the image based on the ambient light and the light from the flash light emission devices 200A and 200B.” Therefore, the image indicated by M in FIG. 7 is displayed on the monitor 121, and the photographer can visually check the image.

The photographer viewing the image may, for example, feel that the projected image of the door 302 (the projected image 402 described in FIG. 3) is dark, and thus want to make the projected image appear brighter in the regular photographing. Further, the photographer may want to know the image expected to be obtained by such thus photographing. In this case, with the use of the input device 104, the photographer specifies “the intensity of the ambient light” as 2 times. This specification is transmitted to the CPU 101 via the bus 105. Further, the CPU 101 transmits to the digital signal processor 117, via the bus 105, a command to “perform the processing with the values P, Q, and R set to be 2, 1, and 1, respectively, and display the result of the processing.” This matter will be described in detail with reference to FIG. 8.

In FIG. 8, the Q and R values are the same as the Q and R values in FIG. 7. Therefore, A, B, C, BA, CA, BAM, and CAM are exactly the same as those in FIG. 7. In AM of FIG. 8, the P value is 2. Therefore, the image of AM is twice as bright as the image of A. As illustrated in M of FIG. 8, therefore, in the image based on the image signal M, the projected image of the door 302 (the projected image 402 described in FIG. 3) appears somewhat bright. Further, the left side of the projected image of the person (the projected image 401L illustrated in FIG. 3) appears somewhat bright due to the light from the flash light emission device 200A. Further, the right side of the projected image of the person (the projected image 401R illustrated in FIG. 3) appears somewhat bright due to the light from the flash light emission device 200B.

“The type of the image displayed on the monitor 121” has been set to be “the image based on the ambient light and the light from the flash light emission devices 200A and 200B.” Therefore, the image indicated by M in FIG. 8 is displayed on the monitor 121, and the photographer can visually check the image.

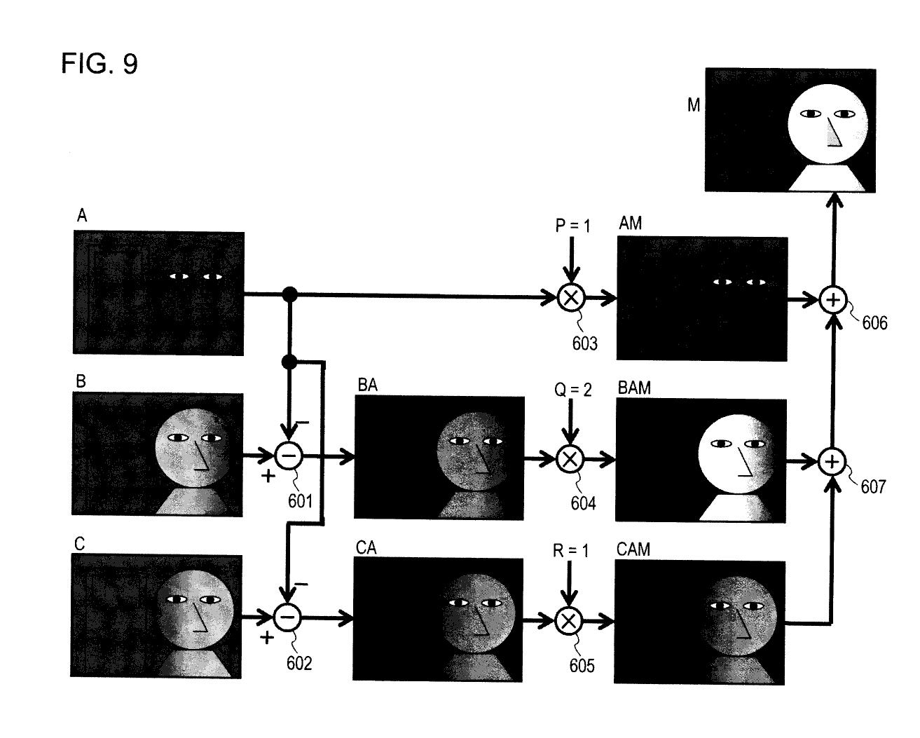

Alternatively, the photographer viewing the image of M in FIG. 7 may want to perform photographing such that the left side of the projected image of the person (the projected image 401L illustrated in FIG. 3) appears brighter. Further, the photographer may want to know the image expected to be obtained by such photographing. In this case, with the use of the input device 104, the photographer specifies “the intensity of the light from the flash light emission device 200A” as 2 times. This specification is transmitted to the CPU 101 via the bus 105. Further, the CPU 101 transmits to the digital signal processor 117, via the bus 105, a command to “perform the processing with the values P, Q, and R set to be 1, 2, and 1, respectively, and display the result of the processing.” This matter will be described in detail with reference to FIG. 9.

In FIG. 9, the P and R values are the same as the P and R values in FIG. 7. Therefore, A, B, C, BA, CA, AM, and CAM are exactly the same as those in FIG. 7. In BAM of FIG. 9, the Q value is 2. Therefore, the image of BAM is twice as bright as the image of BA. As illustrated in M of FIG. 9, therefore, in the image based on the image signal M, the projected image of the door 302 (the projected image 402 described in FIG. 3) appears somewhat dark. Further, the left side of the projected image of the person (the projected image 401L illustrated in FIG. 3) appears substantially bright due to the light from the flash light emission device 200A. Further, the right side of the projected image of the person (the projected image 401R illustrated in FIG. 3) appears somewhat bright due to the light from the flash light emission device 200B.

“The type of the image displayed on the monitor 121” has been set to be “the image based on the ambient light and the light from the flash light emission devices 200A and 200B.” Therefore, the image indicated by M in FIG. 9 is displayed on the monitor 121, and the photographer can visually check the image.

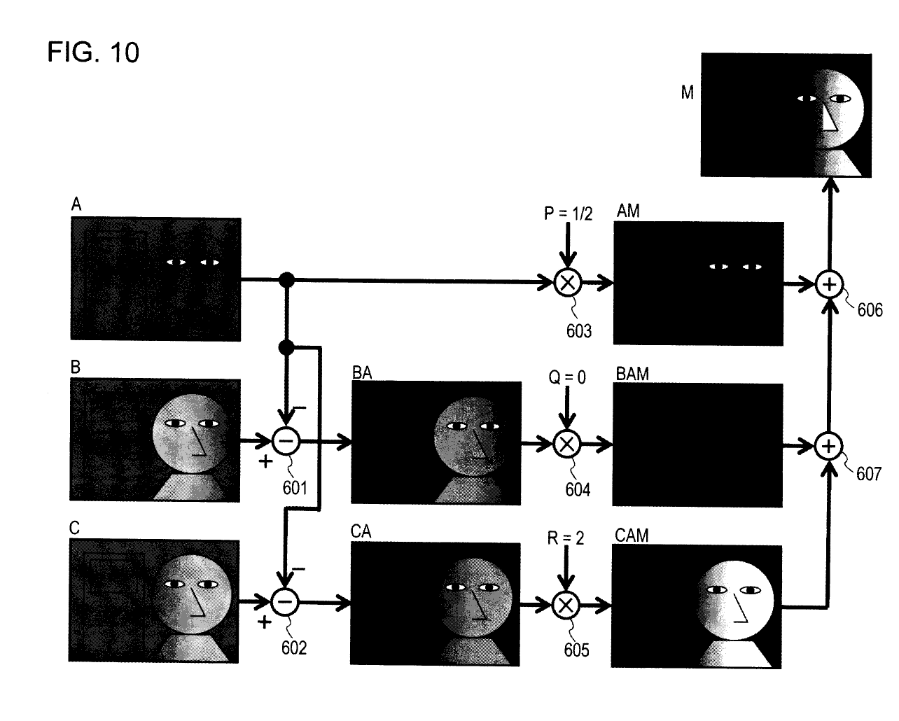

Still alternatively, the photographer viewing the image of M in FIG. 7 may want to perform photographing such that the projected image of the door 302 (the projected image 402 described in FIG. 3) appears darker, that the left side of the projected image of the person (the projected image 401L illustrated in FIG. 3) appears completely dark, and that the right side of the projected image of the person (the projected image 401R illustrated in FIG. 3) appears brighter. Further, the photographer may want to know the image expected to be obtained by such photographing. In this case, with the use of the input device 104, the photographer sets “the intensity of the ambient light” to be ½ times, and specifies “the intensity of the light from the flash light emission device 200A” as 0 time and “the intensity of the light from the flash light emission device 200B” as 2 times. This specification is transmitted to the CPU 101 via the bus 105. Further, the CPU 101 transmits to the digital signal processor 117, via the bus 105, a command to “perform the processing with the values P, Q, and R set to be ½, 0, 2, respectively, and display the result of the processing.” This matter will be described in detail with reference to FIG. 10.

In FIGS. 10, A, B, C, BA, and CA are exactly the same as those in FIG. 7. In AM of FIG. 10, the P value is ½. Therefore, the image of AM is half as bright as the image of A. Further, in BAM of FIG. 10, the Q value is 0. Therefore, the image of BAM is black. Further, in CAM of FIG. 10, the R value is 2. Therefore, the image of CAM is twice as bright as the image of CA. As illustrated in M of FIG. 10, therefore, in the image based on the image signal M, the projected image of the door 302 (the projected image 402 described in FIG. 3) appears dark. Further, the left side of the projected image of the person (the projected image 401L illustrated in FIG. 3) appears somewhat dark due to the completed absence of the light from the flash light emission device 200A. Further, the right side of the projected image of the person (the projected image 401R illustrated in FIG. 3) appears substantially bright due to the light from the flash light emission device 200B.

“The type of the image displayed on the monitor 121” has been set to be “the image based on the ambient light and the light from the flash light emission devices 200A and 200B.” Therefore, the image indicated by M in FIG. 10 is displayed on the monitor 121, and the photographer can visually check the image.

In any of the cases described above with reference to the respective drawings, it is, of course, possible to display on the monitor 121 the image of AM, BAM, or CAM in the respective drawings by specifying “the image based on the ambient light,” “the image based on the light from the flash light emission device 200A,” or “the image based on the light from the flash light emission device 200B” as “the type of the image displayed on the monitor 121.” Accordingly, it is possible to enable the photographer to visually check the image obtainable only with the component of the ambient light, the image obtainable only with the component of the light emitted from the flash light emission device 200A, or the image obtainable only with the component of the light emitted from the flash light emission device 200B.

As described above, at Step ST16 in the flowchart of FIG. 6, it is possible to enable the photographer to visually check the type of image obtainable by photographing performed with “the intensity of the ambient light,” “the intensity of the light from the flash light emission device 200A,” and “the intensity of the light from the flash light emission device 200B” changed in accordance with the simple instruction from the photographer. Accordingly, it is possible to allow the photographer to easily specify “the intensities of the respective light sources” according to the intention of the photographer.

Data relating to “the intensities of the respective light sources (the intensity of the ambient light: P, the intensity of the light from the flash light emission device 200A: Q, and the intensity of the light from the flash light emission device 200B: R)” finally specified by the photographer is stored in the CPU 101, for example, and is used at Step ST18.

Setting of Specific Values of Aperture and Other Conditions: Subsequently, the specific values set at Step ST18 in the flowchart of FIG. 6 will be described. The values set at this Step ST18 include “the aperture,” “the exposure time,” “the light emission amount of the flash light emission device 200A,” and “the light emission amount of the flash light emission device 200B” in the regular photographing.

Although not described above, prior to the processing of the flowchart in FIG. 5, the photographer has selected between “aperture priority” and “shutter speed priority” (selection of the photographing mode) through the input device 104. The photographing mode selecting function is provided to almost all of digital camera products, and thus description thereof will be omitted here. The aperture priority refers to the mode in which photographing is performed with the determined aperture (the above-described F value) unchanged. The shutter speed priority refers to the mode in which photographing is performed with the determined exposure time (the above-described S value) unchanged.

Prior to the process of Step ST18, the photographer at Step ST16 has already specified “the intensities of the respective light sources (the intensity of the ambient light: P, the intensity of the light from the flash light emission device 200A: Q, and the intensity of the light from the flash light emission device 200B: R)” to be used in the regular photographing. Further, this data has been stored in the CPU 101, for example.

If the “aperture priority” has been selected, the CPU 101 performs the regular photographing with the following settings. That is, the CPU 101 performs the regular photographing with the aperture set to be “F,” the exposure time set to be “P×S (i.e., a time P times as long as the time S),” the intensity of the light from the flash light emission device 200A set to be “Q/16 of the maximum light emission amount,” and the intensity of the light from the flash light emission device 200B set to be “R/16 of the maximum light emission amount.” In the regular photographing, therefore, it is possible to obtain the same image as the image visually checked on the monitor 121 when the photographer finally specified the respective values at Step ST16.

Meanwhile, if the “shutter speed priority” has been selected, the CPU 101 performs the regular photographing with the following settings. That is, the CPU 101 performs the regular photographing with the aperture set to be “an aperture P times as bright as the aperture F,” the exposure time set to be “S,” the intensity of the light from the flash light emission device 200A set to be “Q/(P×16) of the maximum light emission amount,” and the intensity of the light from the flash light emission device 200B set to be “R/(P×16) of the maximum light emission amount.” In the regular photographing, therefore, it is possible to obtain the same image as the image visually checked on the monitor 121 when the photographer finally specified the respective values at Step ST16.

As described above, in the digital camera 100 of the imaging system 10 illustrated in FIG. 1, on the basis of the image signals A, B, and C obtained by consecutive photographing performed with the light emission amount of the flash light emission devices 200A and 200B set to be 0 and 1/16 of the maximum light emission amount, the weighted addition signal M of the image signal A based on the ambient light, the image signal BA based on the light emitted from the flash light emission device 200A, and the image signal CA based on the light emitted from the flash light emission device 200B is obtained. Then, the image based on the weighted addition signal M is displayed on the monitor 121 to allow the photographer to set the weighting factors P, Q, and R with reference to the displayed image. On the basis of the weighting factors P, Q, and R set by the photographer, the photographing conditions such as the aperture, the exposure time, and the light emission amount are determined, and the regular photographing is performed. Accordingly, the image intended by the photographer can be easily photographed by the digital camera 100.

### 2. Modified Examples

In the embodiment described above, on the basis of the data of “the intensities of the respective light sources (the intensity of the ambient light: P, the intensity of the light from the flash light emission device 200A: Q, and the intensity of the light from the flash light emission device 200B: R)” to be used in the regular photographing, which is specified by the photographer, the CPU 101 determines the aperture, the exposure time, the light emission amount of the flash light emission device 200A, and the light emission amount of the flash light emission device 200B, and sets the determined values. Thereafter, the CPU 101 performs the regular photographing. Alternatively, however, the CPU 101 may be configured to determine the aperture, the exposure time, the light emission amount of the flash light emission device 200A, and the light emission amount of the flash light emission device 200B, and thereafter display the determined values on the monitor 121, for example, to enable the photographer to view the display and actually manually set the aperture, the exposure time, the light emission amount of the flash light emission device 200A, and the light emission amount of the flash light emission device 200B.

Further, in the embodiment described above, all processing is performed in the digital camera 100. Alternatively, however, the embodiment may be configured, for example, such that the digital camera 100 is connected to a PC (Personal Computer, the illustration of which is omitted), and that the picked-up image data is transferred to and processed in the PC and displayed on a monitor attached to the PC, to thereby enable the photographer to visually check the image.

Further, in the embodiment described above, the description has been made of the example including two flash light emission devices. However, the present invention is, of course, also applicable to an example including one flash light emission device or three or more flash light emission devices.

Further, the photographing at Step ST14 in the flowchart of FIG. 6 may be performed with a sufficiently short exposure time. With this photographing, it is possible to obtain an image signal from photographing performed with “the aperture F” and “the sufficiently short exposure time” under illumination by a light source including two types of light, i.e., the ambient light and the light from the flash light emission device 200A (the amount of the light is 1/16 of the maximum light emission amount). In this case, the exposure time is sufficiently short. Thus, the component of the ambient light is negligible.

Therefore, the thus obtained image signal is substantially equivalent to the image signal obtained by photographing performed with the aperture F under illumination by a light source including the light from the flash light emission device 200A (the amount of the light is 1/16 of the maximum light emission amount) in a state in which the ambient light is absent. That is, even if the image signal is not subjected to the subtraction process, the image signal can be regarded as the above-described image signal BA. Accordingly, it is possible to directly use the image signal B obtained at Step ST14 as the image signal BA, without performing the subtraction process 601 illustrated in FIGS. 7 to 10. The same applies to Step ST15 in the flowchart of FIG. 6.

The present application contains subject matter related to that disclosed in Japanese Priority Patent Application JP 2008-239004 filed in the Japan Patent Office on Sep. 18, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image signal processing device comprising:
an image signal capturing unit configured to capture first and second image signals obtained by consecutive photographing performed by an imaging device under a first photographing condition wherein the aperture of an aperture mechanism of the imaging device is a predetermined aperture, the exposure time of a solid-state image pickup device of the imaging device is a predetermined exposure time, and the light emission amount of a flash light emission device is zero, and a second photographing condition wherein the aperture of the aperture mechanism of the imaging device is a predetermined aperture, the exposure time of the solid-state image pickup device of the imaging device is a predetermined exposure time, and the light emission amount of the flash light emission device is a predetermined light emission amount;
an image signal calculation unit configured to obtain, by the use of the first and second image signals captured by the image signal capturing unit, a weighted addition signal of an image signal based on ambient light and an image signal based on light emitted from the flash light emission device;
a display control unit configured to control the display, on a display unit, of an image based on the weighted addition signal obtained by the image signal calculation unit;
an input device configured to allow a photographer to set respective weighting factors of the image signal based on the ambient light and the image signal based on the light emitted from the flash light emission device, which are subjected to weighted addition by the image signal calculation unit; and
a photographing condition determination unit configured to determine, on the basis of the weighting factors set with the input device, the aperture of the aperture mechanism, the exposure time of the solid-state image pickup device, and the light emission amount of the flash light emission device.

2. The image signal processing device according to claim 1,
wherein the exposure time of the second photographing condition and the exposure time of the first photographing condition are set to be equal to each other, and
wherein the image signal calculation unit uses the first image signal as the image signal based on the ambient light, and uses a subtraction signal resulting from subtraction of the first image signal from the second image signal as the image signal based on the light emitted from the flash light emission device.

3. The image signal processing device according to claim 1,
wherein the exposure time of the second photographing condition is set to be sufficiently shorter than the exposure time of the first photographing condition, and
wherein the image signal calculation unit uses the first image signal as the image signal based on the ambient light, and uses the second image signal as the image signal based on the light emitted from the flash light emission device.

4. The image signal processing device according to claim 1, further comprising:
a photographing condition setting unit configured to set the aperture of the aperture mechanism of the imaging device to be the aperture determined by the photographing condition determination unit, set the exposure time of the solid-state image pickup device of the imaging device to be the exposure time determined by the photographing condition determination unit, and set the light emission amount of the flash light emission device to be the light emission amount determined by the photographing condition determination unit.

5. The image signal processing device according to claim 1,
wherein the display control unit controls the display, on the display unit, of an image obtained from the image signal based on the ambient light and an image obtained from the image signal based on the light emitted from the flash light emission device, as well as the image based on the weighted addition signal obtained by the image signal calculation unit.

6. An image signal processing method comprising the steps of:
capturing first and second image signals obtained by consecutive photographing performed by an imaging device under a first photographing condition wherein the aperture of an aperture mechanism of the imaging device is a predetermined aperture, the exposure time of a solid-state image pickup device of the imaging device is a predetermined exposure time, and the light emission amount of a flash light emission device is zero, and a second photographing condition wherein the aperture of the aperture mechanism of the imaging device is a predetermined aperture, the exposure time of the solid-state image pickup device of the imaging device is a predetermined exposure time, and the light emission amount of the flash light emission device is a predetermined light emission amount;
obtaining, by the use of the first and second image signals captured at the capturing step, a weighted addition signal of an image signal based on ambient light and an image signal based on light emitted from the flash light emission device;
controlling the display, on a display unit, of an image based on the weighted addition signal obtained at the obtaining step;
allowing a photographer to set respective weighting factors of the image signal based on the ambient light and the image signal based on the light emitted from the flash light emission device, which are subjected to weighted addition at the obtaining step; and
determining, on the basis of the weighting factors set at the allowing step, the aperture of the aperture mechanism, the exposure time of the solid-state image pickup device, and the light emission amount of the flash light emission device.

7. A program causing a computer to function as:
image signal capturing means for capturing first and second image signals obtained by consecutive photographing performed by an imaging device under a first photographing condition wherein the aperture of an aperture mechanism of the imaging device is a predetermined aperture, the exposure time of a solid-state image pickup device of the imaging device is a predetermined exposure time, and the light emission amount of a flash light emission device is zero, and a second photographing condition wherein the aperture of the aperture mechanism of the imaging device is a predetermined aperture, the exposure time of the solid-state image pickup device of the imaging device is a predetermined exposure time, and the light emission amount of the flash light emission device is a predetermined light emission amount;
image signal calculation means for obtaining, by the use of the first and second image signals captured by the image signal capturing means, a weighted addition signal of an image signal based on ambient light and an image signal based on light emission from the flash light emission device;
display control means for controlling the display, on a display unit, of an image based on the weighted addition signal obtained by the image signal calculation means;
photographer operation means for allowing a photographer to set respective weighting factors of the image signal based on the ambient light and the image signal based on the light emitted from the flash light emission device, which are subjected to weighted addition by the image signal calculation means; and
photographing condition determination means for determining, on the basis of the weighting factors set by the photographer operation means, the aperture of the aperture mechanism, the exposure time of the solid-state image pickup device, and the light emission amount of the flash light emission device.

8. An imaging device comprising:
a solid-state image pickup device configured to pick up an image of a subject;
an aperture mechanism configured to adjust the amount of light from the subject transmitted therethrough and incident on the solid-state image pickup device;
a picked-up image signal processing unit configured to process a picked-up image signal obtained by the solid-state image pickup device to obtain an image signal;
a recording unit configured to store, in a recording medium, the image signal obtained by the picked-up image signal processing unit;
a light emission control unit configured to control light emission of a flash light emission device; and
an image signal processing unit configured to process the image signal obtained by the picked-up image signal processing unit, and set the aperture of the aperture mechanism, the exposure time of the solid-state image pickup device, and the light emission amount of the flash light emission device,
wherein the image signal processing unit includes
an image signal capturing unit configured to capture first and second image signals obtained by the picked-up image signal processing unit through consecutive photographing performed under a first photographing condition wherein the aperture of the aperture mechanism is a predetermined aperture, the exposure time of the solid-state image pickup device is a predetermined exposure time, and the light emission amount of the flash light emission device is zero, and a second photographing condition wherein the aperture of the aperture mechanism is a predetermined aperture, the exposure time of the solid-state image pickup device is a predetermined exposure time, and the light emission amount of the flash light emission device is a predetermined light emission amount,
an image signal calculation unit configured to obtain, by the use of the first and second image signals captured by the image signal capturing unit, a weighted addition signal of an image signal based on ambient light and an image signal based on light emitted from the flash light emission device,
a display control unit configured to control the display, on a display unit, of an image based on the weighted addition signal obtained by the image signal calculation unit,
an input device configured to allow a photographer to set respective weighting factors of the image signal based on the ambient light and the image signal based on the light emitted from the flash light emission device, which are subjected to weighted addition by the image signal calculation unit,
a photographing condition determination unit configured to determine, on the basis of the weighting factors set with the input device, the aperture of the aperture mechanism, the exposure time of the solid-state image pickup device, and the light emission amount of the flash light emission device, and
a photographing condition setting unit configured to set the aperture of the aperture mechanism of the imaging device to be the aperture determined by the photographing condition determination unit, set the exposure time of the solid-state image pickup device of the imaging device to be the exposure time determined by the photographing condition determination unit, and set the light emission amount of the flash light emission device to be the light emission amount determined by the photographing condition determination unit.

9. An imaging system comprising an imaging device and a flash light emission device,
wherein the imaging device includes
a solid-state image pickup device configured to pick up an image of a subject,
an aperture mechanism configured to adjust the amount of light from the subject transmitted therethrough and incident on the solid-state image pickup device,
a picked-up image signal processing unit configured to process a picked-up image signal obtained by the solid-state image pickup device to obtain an image signal,
a recording unit configured to store, in a recording medium, the image signal obtained by the picked-up image signal processing unit,
a light emission control unit configured to control light emission of the flash light emission device, and
an image signal processing unit configured to process the image signal obtained by the picked-up image signal processing unit, and set the aperture of the aperture mechanism, the exposure time of the solid-state image pickup device, and the light emission amount of the flash light emission device, and
wherein the image signal processing unit includes
an image signal capturing unit configured to capture first and second image signals obtained by the picked-up image signal processing unit through consecutive photographing performed under a first photographing condition wherein the aperture of the aperture mechanism is a predetermined aperture, the exposure time of the solid-state image pickup device is a predetermined exposure time, and the light emission amount of the flash light emission device is zero, and a second photographing condition wherein the aperture of the aperture mechanism is a predetermined aperture, the exposure time of the solid-state image pickup device is a predetermined exposure time, and the light emission amount of the flash light emission device is a predetermined light emission amount,
an image signal calculation unit configured to obtain, by the use of the first and second image signals captured by the image signal capturing unit, a weighted addition signal of an image signal based on ambient light and an image signal based on light emitted from the flash light emission device,
a display control unit configured to control the display, on a display unit, of an image based on the weighted addition signal obtained by the image signal calculation unit,
an input device configured to allow a photographer to set respective weighting factors of the image signal based on the ambient light and the image signal based on the light emitted from the flash light emission device, which are subjected to weighted addition by the image signal calculation unit,
a photographing condition determination unit configured to determine, on the basis of the weighting factors set with the input device, the aperture of the aperture mechanism, the exposure time of the solid-state image pickup device, and the light emission amount of the flash light emission device, and
a photographing condition setting unit configured to set the aperture of the aperture mechanism of the imaging device to be the aperture determined by the photographing condition determination unit, set the exposure time of the solid-state image pickup device of the imaging device to be the exposure time determined by the photographing condition determination unit, and set the light emission amount of the flash light emission device to be the light emission amount determined by the photographing condition determination unit.
